(19) United States
(12) Patent Application Publication
(10) Pub. No.: US 2025/0088251 A1
(43) Pub. Date: Mar. 13, 2025

(54) CHANNEL SOUNDING PROCESS IN A WIRELESS NETWORK

(71) Applicant: NEWRACOM, Inc., Irvine, CA (US)

(72) Inventors: Heejung YU, Daejeon (KR); Joonsoo LEE, Seoul (KR); Si-Chan NOH, Seoul (KR); Il-Gu LEE, Seoul (KR)

(73) Assignee: NEWRACOM, Inc., Irvine, CA (US)

(21) Appl. No.: 18/818,409

(22) Filed: Aug. 28, 2024

Related U.S. Application Data
(60) Provisional application No. 63/581,815, filed on Sep. 11, 2023.

(51) Int. Cl. H04B 7/06; H04B 7/0413; H04L 5/00; H04W 72/12

(52) U.S. Cl. CPC H04B 7/0632; H04B 7/0413; H04L 5/0057; H04W 72/12

(57) ABSTRACT

An embodiment is method performed by a first beamformee to participate in a channel sounding process. The method includes receiving a null data packet (NDP) announcement frame from a beamformer, wherein the NDP announcement frame includes partial bandwidth information for the first beamformee and partial bandwidth information for a second beamformee, each indicating a same first bandwidth. The method further includes responsive to receiving a beamforming report poll (BFRP) trigger frame from the beamformer, transmitting a first report frame and a second report frame to the beamformer, wherein the first report frame includes a first partial bandwidth change indication bit indicating there is a change in partial bandwidth for the first beamformee and the second report frame includes a second partial bandwidth change indication bit indicating there is a change in partial bandwidth for the second beamformee.

### CROSS-REFERENCE TO RELATED APPLICATION

This application claims the benefit of U.S. Provisional Application No. 63/581,815 filed Sep. 11, 2023, which is hereby incorporated by reference.

### TECHNICAL FIELD

The present disclosure generally relates to wireless communications, and more specifically, relates to a channel sounding process in a wireless network.

### BACKGROUND

Institute of Electrical and Electronics Engineers (IEEE) 802.11 is a set of standards for implementing wireless local area network communication in various frequencies, including but not limited to the 2.4 gigahertz (GHz), 5 GHZ, 6 GHz, and 60 GHz bands. These standards define the protocols that enable Wi-Fi devices to communicate with each other. The IEEE 802.11 family of standards has evolved over time to accommodate higher data rates, improved security, and better performance in different environments. Some of the most widely used standards include 802.11a, 802.11b, 802.11g, 802.11n, 802.11ac, and 802.11ax (also known as “Wi-Fi 6”). These standards specify the modulation techniques, channel bandwidths, and other technical aspects that facilitate interoperability between devices from various manufacturers. IEEE 802.11 has played an important role in the widespread adoption of wireless networking in homes, offices, and public spaces, enabling users to connect their devices to the internet and each other without the need for wired connections.

IEEE 802.11be, also known as “Wi-Fi 7”, is the next generation of the IEEE 802.11 family of standards for wireless local area networks. Currently under development, 802.11be aims to significantly improve upon the capabilities of its predecessor, 802.11ax/Wi-Fi 6, by offering even higher data rates, lower latency, and increased reliability. The standard is expected to leverage advanced technologies such as multi-link operation (MLO), which allows devices to simultaneously use multiple frequency bands and channels for enhanced performance and reliability. Additionally, 802.11be will introduce 4096-QAM (Quadrature Amplitude Modulation), enabling higher data rates by encoding more bits per symbol. The standard will also feature improved medium access control (MAC) efficiency, enhanced power saving capabilities, and better support for high-density environments. With these advancements, 802.11be is expected to deliver theoretical maximum data rates of up to 46 gigabits per second (Gbps), making it suitable for bandwidth-intensive applications such as virtual and augmented reality, 8K video streaming, and high-performance gaming. The IEEE 802.11be standard is projected to be finalized by the end of 2024, paving the way for the next generation of Wi-Fi devices and networks.

One of the objectives of future wireless networks (e.g., wireless networks that will implement the IEEE 802.11bn or beyond IEEE 802.11be wireless networking standard) is to improve the range-vs-rate performance. Relay operations are being considered as one of the solutions to achieve this objective. Relay operations may be combined with beamformed transmission to further improve the range-vs-rate performance. A channel sounding process may be used to determine the beamforming matrix to use for a beamformed transmission. However, the existing channel sounding processes (e.g., the channel sounding process defined in the IEEE 802.11be wireless networking standard) do not take relay operations into consideration, which can result in inefficient transmissions when relay operations are employed.

### BRIEF DESCRIPTION OF THE DRAWINGS

The disclosure will be more fully understood from the detailed description provided below and the accompanying drawings that depict various embodiments of the disclosure. However, these drawings should not be interpreted as limiting the disclosure to the specific embodiments shown; they are provided for explanation and understanding only.

FIG. 1 illustrates an example of a wireless local area network (WLAN) with a basic service set (BSS) that includes multiple wireless devices, in accordance with some embodiments of the present disclosure.

FIG. 2 is a schematic diagram of a wireless device, in accordance with some embodiments of the present disclosure.

FIG. 3A illustrates components of a wireless device configured to transmit data, in accordance with some embodiments of the present disclosure.

FIG. 3B illustrates components of a wireless device configured to receive data, in accordance with some embodiments of the present disclosure.

FIG. 4 illustrates interframe space (IFS) relationships, in accordance with some embodiments of the present disclosure.

FIG. 5 illustrates a Carrier Sense Multiple Access with Collision Avoidance (CSMA/CA)-based frame transmission procedure, in accordance with some embodiments of the present disclosure.

FIG. 6 illustrates maximum physical layer (PHY) rates for Institute of Electrical and Electronics Engineers (IEEE) 802.11 standards, in accordance with some embodiments of the present disclosure.

FIG. 7 provides a detailed description of fields in Extremely High Throughput (EHT) Physical Protocol Data Unit (PPDU) frames, including their purposes and characteristics, in accordance with some embodiments of the present disclosure.

FIG. 8 illustrates an example of multi-user (MU) transmission in Orthogonal Frequency-Division Multiple Access (OFDMA), in accordance with some embodiments of the present disclosure.

FIG. 9 illustrates an example of an access point sending a trigger frame to multiple associated stations and receiving Uplink Orthogonal Frequency-Division Multiple Access Trigger-Based Physical Protocol Data Units (UL OFDMA TB PPDUs) in response, in accordance with some embodiments of the present disclosure.

FIG. 10 is a diagram showing an example of a relayed downlink transmission, according to some embodiments.

FIG. 11 is a diagram showing an example of a channel sounding process involving multiple beamformees, according to some embodiments.

FIG. 12 is a diagram showing a format of a NDP announcement frame, according to some embodiments.

FIG. 13 is a diagram showing a format of a STA info field, according to some embodiments.

FIG. 14 is a diagram showing a format of a MIMO control field included in a compressed beamforming/CQI report frame, according to some embodiments.

FIG. 15 is a diagram showing an example of a channel sounding process and a MU-MIMO transmission, according to some embodiments.

FIG. 16 is a flowchart of a method for performing a channel sounding process, according to some embodiments.

FIG. 17 is a flowchart of a method for participating in a channel sounding process, according to some embodiments.

### DETAILED DESCRIPTION

The present disclosure generally relates to wireless communications, and more specifically, relates to a channel sounding process in a wireless network.

As mentioned above, existing channel sounding processes (e.g., the channel sounding process defined in the IEEE 802.11be wireless networking standard) do not take relay operations into consideration. With relay operations, a relay station (STA) may act as a relay between an access point (AP) and a non-relay STA. The AP may transmit data intended for the relay STA, as well as data intended for the non-relay STA that is to be relayed by the relay STA. The AP may initiate a channel sounding process to obtain channel feedback information (e.g., compressed beamforming information and/or channel quality information (CQI)) from the relay STA and the non-relay STA so that the AP can perform a multi-user multiple-input multiple-output (MU-MIMO) transmission to the relay STA and the non-relay STA. In such a scenario, the AP may operate as a beamformer and the relay STA and non-relay STA may operate as beamformees. With the existing channel sounding process, the beamformer decides the type of channel feedback information that the beamformees should provide to the beamformer, and the beamformees should follow the decision of the beamformer. Thus, in the relay operation scenario mentioned above, the AP (as the beamformer) decides the type of channel feedback information that the STAs should provide to the AP, and the STAs should follow the decision of the AP. The relay operation may be transparent to the AP. That is, the AP may not be aware of the existence of the relay operation. Thus, the AP may request channel feedback information from the relay STA and the non-relay STA for the same partial bandwidth (for a MU-MIMO transmission). Since the relay STA acts as a relay between the AP and the non-relay STA, the relay STA may respond to the AP's request with channel feedback information for both itself and for the non-relay STA, resulting in the relay STA providing the same channel feedback information to the AP for both the relay STA and the non-relay STA. Because of this, the AP may not be able to determine the MU-MIMO beamforming matrix to minimize the inter-STA interference. In the relay operation scenario, it may be better for the AP to use different frequency resources (e.g., different partial bandwidths) to transmit data to the relay STA and the non-relay STA. However, the AP requests channel feedback information for the same partial bandwidth because the AP does not recognize the existence of the relay operation.

The present disclosure describes a channel sounding process that enables proper MU-MIMO beamforming in relay operation scenarios. The channel sounding process disclosed herein may allow the relay STA to inform the AP that the AP should use a different partial bandwidth for transmitting data to the relay STA and the non-relay STA. For example, the relay STA may inform the AP that the AP should use a first partial bandwidth within the originally specified partial bandwidth (specified by the AP) to transmit data to the relay STA and use a second partial bandwidth within the originally specified partial bandwidth (which is different from the first partial bandwidth) to transmit data to the non-relay STA. As a result, the AP may transmit data to the relay STA and the non-relay STA in an OFDMA manner, which is more efficient in the relay operation scenario compared to a non-OFDMA transmission. As will be described in further detail herein, frame(s) that are used in the existing channel sounding process (e.g., the channel sounding process defined in the IEEE 802.11 wireless networking standard) may be modified to allow the beamformee to indicate that the beamformer should use a different partial bandwidth.

According to some embodiments, a beamformer initiates a channel sounding process by transmitting a null data packet (NDP) announcement frame, wherein the NDP announcement frame includes partial bandwidth information for a first beamformee and partial bandwidth information for a second beamformee, each indicating a same first bandwidth. The beamformer may then transmit a NDP frame followed by a beamforming report poll (BFRP) trigger frame to solicit report frames from the first beamformee and the second beamformee. Responsive to receiving the BFRP trigger frame, the first beamformee may transmit a first report frame and a second report frame to the beamformer, wherein the first report frame includes a first MIMO control field that includes a first partial bandwidth change indication bit indicating there is a change in partial bandwidth for the first beamformee and first partial bandwidth information indicating a first partial bandwidth for the first beamformee (the partial bandwidth that is to be used for transmitting data to the first beamformee) that is within the first bandwidth, wherein the second report frame includes a second MIMO control field that includes a second partial bandwidth change indication bit indicating there is a change in partial bandwidth for the second beamformee and second partial bandwidth information indicating a second partial bandwidth for the second beamformee (the partial bandwidth that is to be used for transmitting data to the second beamformee) that is within the first bandwidth. Responsive to receiving the first report frame and the second report frame, the beamformer may transmit a MU-MIMO data frame that includes data intended for the first beamformee in the first partial bandwidth and data intended for the second beamformee in the second partial bandwidth (in an orthogonal frequency division multiple access (OFDMA) manner).

The new channel sounding process described herein may allow for more efficient transmission in relay operation scenarios (when the AP transmits data for both the relay STA and the non-relay STA, it is more efficient for the relay STA to transmit the data in an OFDMA manner).

For purposes of illustration, various embodiments are described herein in the context of wireless networks that are based on IEEE 802.11 standards and using terminology and concepts thereof. Those skilled in the art will appreciate that the embodiments disclosed herein can be modified/adapted for use in other types of wireless networks.

In the following detailed description, only certain embodiments of the present invention have been shown and described, simply by way of illustration. As those skilled in the art would realize, the described embodiments may be modified in different ways, all without departing from the spirit or scope of the present invention. Accordingly, the drawings and description are to be regarded as illustrative in nature and not restrictive. Like reference numerals designate like elements throughout the specification.

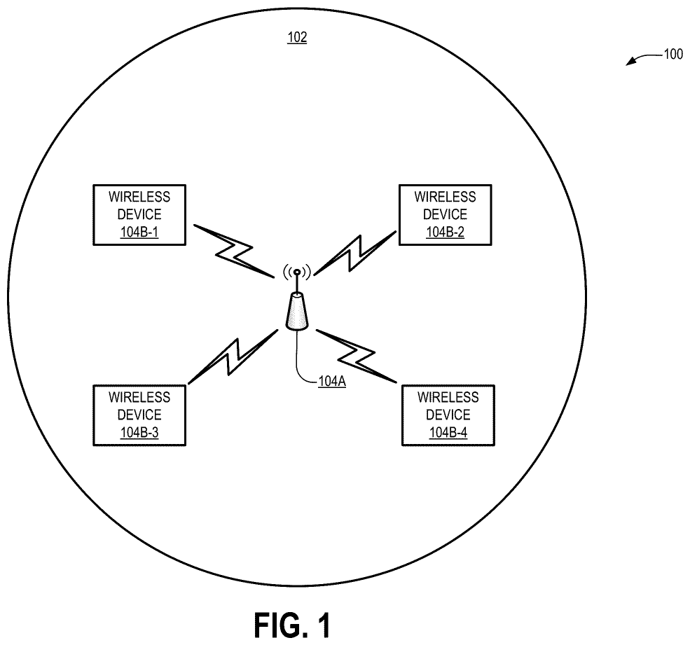

FIG. 1 shows a wireless local area network (WLAN) 100 with a basic service set (BSS) 102 that includes a plurality of wireless devices 104 (sometimes referred to as WLAN devices 104). Each of the wireless devices 104 may include a medium access control (MAC) layer and a physical (PHY) layer according to an IEEE (Institute of Electrical and Electronics Engineers) standard 802.11, including one or more of the amendments (e.g., 802.11a/b/g/n/p/ac/ax/bd/be). In one embodiment, the MAC layer of a wireless device 104 may initiate transmission of a frame to another wireless device 104 by passing a PHY-TXSTART.request (TXVECTOR) to the PHY layer. The TXVECTOR provides parameters for generating and/or transmitting a corresponding frame. Similarly, a PHY layer of a receiving wireless device may generate an RXVECTOR, which includes parameters of a received frame and is passed to a MAC layer for processing.

The plurality of wireless devices 104 may include a wireless device 104A that is an access point (sometimes referred to as an AP station or AP STA) and the other wireless devices 104B₁-104B₄ that are non-AP stations (sometimes referred to as non-AP STAs). Alternatively, all the plurality of wireless devices 104 may be non-AP STAs in an ad-hoc networking environment. In general, the AP STA (e.g., wireless device 104A) and the non-AP STAs (e.g., wireless devices 104B₁-104B₄) may be collectively referred to as STAs. However, for ease of description, only the non-AP STAs may be referred to as STAs unless the context indicates otherwise. Although shown with four non-AP STAs (e.g., the wireless devices 104B₁-104B₄), the WLAN 100 may include any number of non-AP STAs (e.g., one or more wireless devices 104B).

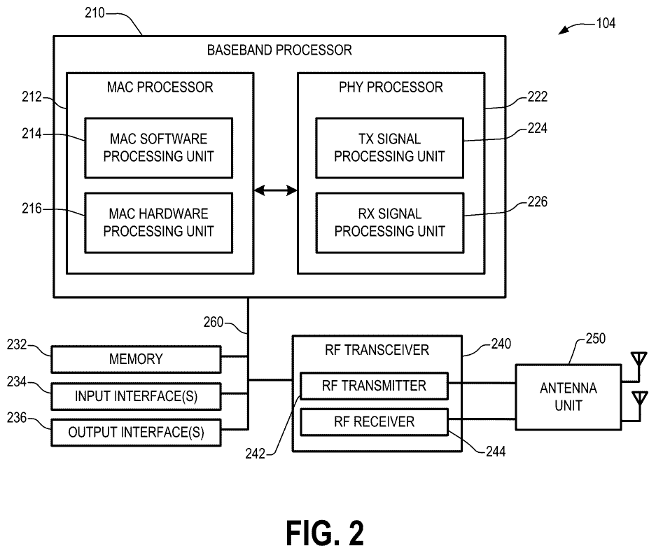

FIG. 2 illustrates a schematic block diagram of a wireless device 104, according to an embodiment. The wireless device 104 may be the wireless device 104A (i.e., the AP of the WLAN 100) or any of the wireless devices 104B₁-104B₄ in FIG. 1. The wireless device 104 includes a baseband processor 210, a radio frequency (RF) transceiver 240, an antenna unit 250, a storage device (e.g., memory device) 232, one or more input interfaces 234, and one or more output interfaces 236. The baseband processor 210, the storage device 232, the input interfaces 234, the output interfaces 236, and the RF transceiver 240 may communicate with each other via a bus 260.

The baseband processor 210 performs baseband signal processing and includes a MAC processor 212 and a PHY processor 222. The baseband processor 210 may utilize the memory 232, which may include a non-transitory computer/machine readable medium having software (e.g., computer/machine programing instructions) and data stored therein.

In an embodiment, the MAC processor 212 includes a MAC software processing unit 214 and a MAC hardware processing unit 216. The MAC software processing unit 214 may implement a first plurality of functions of the MAC layer by executing MAC software, which may be included in the software stored in the storage device 232. The MAC hardware processing unit 216 may implement a second plurality of functions of the MAC layer in special-purpose hardware. However, the MAC processor 212 is not limited thereto. For example, the MAC processor 212 may be configured to perform the first and second plurality of functions entirely in software or entirely in hardware according to an implementation.

The PHY processor 222 includes a transmitting (TX) signal processing unit (SPU) 224 and a receiving (RX) SPU 226. The PHY processor 222 implements a plurality of functions of the PHY layer. These functions may be performed in software, hardware, or a combination thereof according to an implementation.

Functions performed by the transmitting SPU 224 may include one or more of Forward Error Correction (FEC) encoding, stream parsing into one or more spatial streams, diversity encoding of the spatial streams into a plurality of space-time streams, spatial mapping of the space-time streams to transmit chains, inverse Fourier Transform (iFT) computation, Cyclic Prefix (CP) insertion to create a Guard Interval (GI), and the like. Functions performed by the receiving SPU 226 may include inverses of the functions performed by the transmitting SPU 224, such as GI removal, Fourier Transform computation, and the like.

The RF transceiver 240 includes an RF transmitter 242 and an RF receiver 244. The RF transceiver 240 is configured to transmit first information received from the baseband processor 210 to the WLAN 100 (e.g., to another WLAN device 104 of the WLAN 100) and provide second information received from the WLAN 100 (e.g., from another WLAN device 104 of the WLAN 100) to the baseband processor 210.

The antenna unit 250 includes one or more antennas. When Multiple-Input Multiple-Output (MIMO) or Multi-User MIMO (MU-MIMO) is used, the antenna unit 250 may include a plurality of antennas. In an embodiment, the antennas in the antenna unit 250 may operate as a beam-formed antenna array. In an embodiment, the antennas in the antenna unit 250 may be directional antennas, which may be fixed or steerable.

The input interfaces 234 receive information from a user, and the output interfaces 236 output information to the user. The input interfaces 234 may include one or more of a keyboard, keypad, mouse, touchscreen, microphone, and the like. The output interfaces 236 may include one or more of a display device, touch screen, speaker, and the like.

As described herein, many functions of the WLAN device 104 may be implemented in either hardware or software. Which functions are implemented in software and which functions are implemented in hardware will vary according to constraints imposed on a design. The constraints may include one or more of design cost, manufacturing cost, time to market, power consumption, available semiconductor technology, etc.

As described herein, a wide variety of electronic devices, circuits, firmware, software, and combinations thereof may be used to implement the functions of the components of the WLAN device 104. Furthermore, the WLAN device 104 may include other components, such as application processors, storage interfaces, clock generator circuits, power supply circuits, and the like, which have been omitted in the interest of brevity.

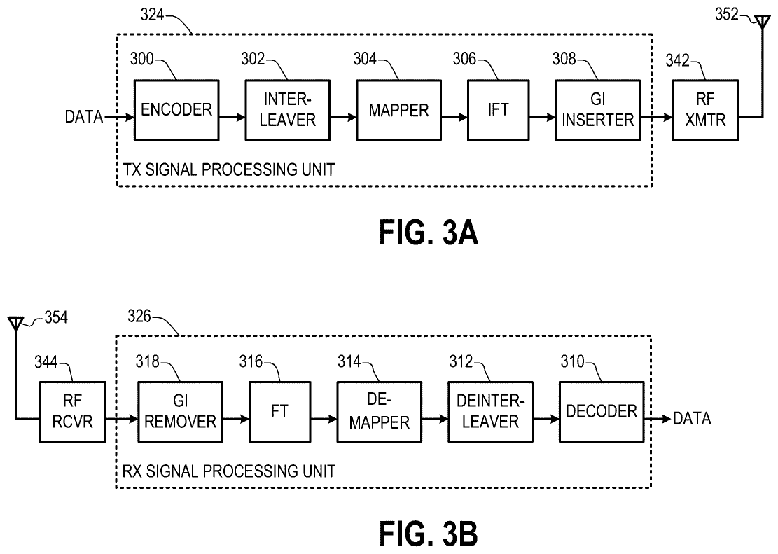

FIG. 3A illustrates components of a WLAN device 104 configured to transmit data according to an embodiment, including a transmitting (Tx) SPU (TxSP) 324, an RF transmitter 342, and an antenna 352. In an embodiment, the TxSP 324, the RF transmitter 342, and the antenna 352 correspond to the transmitting SPU 224, the RF transmitter 242, and an antenna of the antenna unit 250 of FIG. 2, respectively.

The TxSP 324 includes an encoder 300, an interleaver 302, a mapper 304, an inverse Fourier transformer (IFT) 306, and a guard interval (GI) inserter 308.

The encoder 300 receives and encodes input data. In an embodiment, the encoder 300 includes a forward error correction (FEC) encoder. The FEC encoder may include a binary convolution code (BCC) encoder followed by a puncturing device. The FEC encoder may include a low-density parity-check (LDPC) encoder.

The TxSP 324 may further include a scrambler for scrambling the input data before the encoding is performed by the encoder 300 to reduce the probability of long sequences of 0s or 1s. When the encoder 300 performs the BCC encoding, the TxSP 324 may further include an encoder parser for demultiplexing the scrambled bits among a plurality of BCC encoders. If LDPC encoding is used in the encoder, the TxSP 324 may not use the encoder parser.

The interleaver 302 interleaves the bits of each stream output from the encoder 300 to change an order of bits therein. The interleaver 302 may apply the interleaving only when the encoder 300 performs BCC encoding and otherwise may output the stream output from the encoder 300 without changing the order of the bits therein.

The mapper 304 maps the sequence of bits output from the interleaver 302 to constellation points. If the encoder 300 performed LDPC encoding, the mapper 304 may also perform LDPC tone mapping in addition to constellation mapping.

When the TxSP 324 performs a MIMO or MU-MIMO transmission, the TxSP 324 may include a plurality of interleavers 302 and a plurality of mappers 304 according to a number of spatial streams (NSS) of the transmission. The TxSP 324 may further include a stream parser for dividing the output of the encoder 300 into blocks and may respectively send the blocks to different interleavers 302 or mappers 304. The TxSP 324 may further include a space-time block code (STBC) encoder for spreading the constellation points from the spatial streams into a number of space-time streams (NSTS) and a spatial mapper for mapping the space-time streams to transmit chains. The spatial mapper may use direct mapping, spatial expansion, or beamforming.

The IFT 306 converts a block of the constellation points output from the mapper 304 (or, when MIMO or MU-MIMO is performed, the spatial mapper) to a time domain block (i.e., a symbol) by using an inverse discrete Fourier transform (IDFT) or an inverse fast Fourier transform (IFFT). If the STBC encoder and the spatial mapper are used, the IFT 306 may be provided for each transmit chain.

When the TxSP 324 performs a MIMO or MU-MIMO transmission, the TxSP 324 may insert cyclic shift diversities (CSDs) to prevent unintentional beamforming. The TxSP 324 may perform the insertion of the CSD before or after the IFT 306. The CSD may be specified per transmit chain or may be specified per space-time stream. Alternatively, the CSD may be applied as a part of the spatial mapper.

When the TxSP 324 performs a MIMO or MU-MIMO transmission, some blocks before the spatial mapper may be provided for each user.

The GI inserter 308 prepends a GI to each symbol produced by the IFT 306. Each GI may include a Cyclic Prefix (CP) corresponding to a repeated portion of the end of the symbol that the GI precedes. The TxSP 324 may optionally perform windowing to smooth edges of each symbol after inserting the GI.

The RF transmitter 342 converts the symbols into an RF signal and transmits the RF signal via the antenna 352. When the TxSP 324 performs a MIMO or MU-MIMO transmission, the GI inserter 308 and the RF transmitter 342 may be provided for each transmit chain.

FIG. 3B illustrates components of a WLAN device 104 configured to receive data according to an embodiment, including a Receiver (Rx) SPU (RxSP) 326, an RF receiver 344, and an antenna 354. In an embodiment, the RxSP 326, RF receiver 344, and antenna 354 may correspond to the receiving SPU 226, the RF receiver 244, and an antenna of the antenna unit 250 of FIG. 2, respectively.

The RxSP 326 includes a GI remover 318, a Fourier transformer (FT) 316, a demapper 314, a deinterleaver 312, and a decoder 310.

The RF receiver 344 receives an RF signal via the antenna 354 and converts the RF signal into symbols. The GI remover 318 removes the GI from each of the symbols. When the received transmission is a MIMO or MU-MIMO transmission, the RF receiver 344 and the GI remover 318 may be provided for each receive chain.

The FT 316 converts each symbol (that is, each time domain block) into a frequency domain block of constellation points by using a discrete Fourier transform (DFT) or a fast Fourier transform (FFT). The FT 316 may be provided for each receive chain.

When the received transmission is the MIMO or MU-MIMO transmission, the RxSP 326 may include a spatial demapper for converting the respective outputs of the FTs 316 of the receiver chains to constellation points of a plurality of space-time streams, and an STBC decoder for despreading the constellation points from the space-time streams into one or more spatial streams.

The demapper 314 demaps the constellation points output from the FT 316 or the STBC decoder to bit streams. If the received transmission was encoded using LDPC encoding, the demapper 314 may further perform LDPC tone demapping before performing the constellation demapping.

The deinterleaver 312 deinterleaves the bits of each stream output from the demapper 314. The deinterleaver 312 may perform the deinterleaving only when the received transmission was encoded using BCC encoding, and otherwise may output the stream output by the demapper 314 without performing deinterleaving.

When the received transmission is the MIMO or MU-MIMO transmission, the RxSP 326 may use a plurality of demappers 314 and a plurality of deinterleavers 312 corresponding to the number of spatial streams of the transmission. In this case, the RxSP 326 may further include a stream deparser for combining the streams output from the deinterleavers 312.

The decoder 310 decodes the streams output from the deinterleaver 312 or the stream deparser. In an embodiment, the decoder 310 includes an FEC decoder. The FEC decoder may include a BCC decoder or an LDPC decoder.

The RxSP 326 may further include a descrambler for descrambling the decoded data. When the decoder 310 performs BCC decoding, the RxSP 326 may further include an encoder deparser for multiplexing the data decoded by a plurality of BCC decoders. When the decoder 310 performs the LDPC decoding, the RxSP 326 may not use the encoder deparser.

Before making a transmission, wireless devices such as wireless device 104 will assess the availability of the wireless medium using Clear Channel Assessment (CCA). If the medium is occupied, CCA may determine that it is busy, while if the medium is available, CCA determines that it is idle.

The PHY entity for IEEE 802.11 is based on Orthogonal Frequency Division Multiplexing (OFDM) or Orthogonal Frequency Division Multiple Access (OFDMA). In either OFDM or OFDMA Physical (PHY) layers, a STA (e.g., a wireless device 104) is capable of transmitting and receiving Physical Layer (PHY) Protocol Data Units (PPDUs) (also referred to as PLCP (Physical Layer Convergence Procedure) Protocol Data Units) that are compliant with the mandatory PHY specifications. A PHY specification defines a set of Modulation and Coding Schemes (MCS) and a maximum number of spatial streams. Some PHY entities define downlink (DL) and uplink (UL) Multi-User (MU) transmissions having a maximum number of space-time streams (STS) per user and employing up to a predetermined total number of STSs. A PHY entity may provide support for 10 Megahertz (MHz), 20 MHz, 40 MHz, 80 MHz, 160 MHz, 240 MHz, and 320 MHz contiguous channel widths and support for an 80+80, 80+160 MHz, and 160+160 MHz non-contiguous channel width. Each channel includes a plurality of subcarriers, which may also be referred to as tones. A PHY entity may define signaling fields denoted as Legacy Signal (L-SIG), Signal A (SIG-A), and Signal B (SIG-B), and the like within a PPDU by which some necessary information about PHY Service Data Unit (PSDU) attributes are communicated. The descriptions below, for sake of completeness and brevity, refer to OFDM-based 802.11 technology. Unless otherwise indicated, a station refers to a non-AP STA.

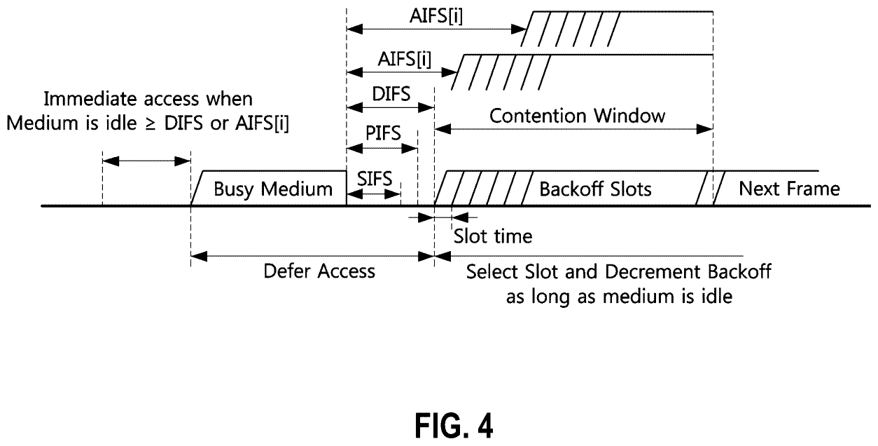

FIG. 4 illustrates Inter-Frame Space (IFS) relationships. In particular, FIG. 4 illustrates a Short IFS (SIFS), a Point Coordination Function (PCF) IFS (PIFS), a Distributed Coordination Function (DCF) IFS (DIFS), and an Arbitration IFSs corresponding to an Access Category (AC) ‘i’ (AIFS[i]). FIG. 4 also illustrates a slot time and a data frame is used for transmission of data forwarded to a higher layer. As shown, a WLAN device 104 transmits the data frame after performing backoff if a DIFS has elapsed during which the medium has been idle.

A management frame may be used for exchanging management information, which is not forwarded to the higher layer. Subtype frames of the management frame include a beacon frame, an association request/response frame, a probe request/response frame, and an authentication request/response frame.

A control frame may be used for controlling access to the medium. Subtype frames of the control frame include a request to send (RTS) frame, a clear to send (CTS) frame, and an acknowledgement (ACK) frame.

When the control frame is not a response frame of another frame, the WLAN device 104 transmits the control frame after performing backoff if a DIFS has elapsed during which the medium has been idle. When the control frame is the response frame of another frame, the WLAN device 104 transmits the control frame after a SIFS has elapsed without performing backoff or checking whether the medium is idle.

A WLAN device 104 that supports Quality of Service (QoS) functionality (that is, a QoS STA) may transmit the frame after performing backoff if an AIFS for an associated access category (AC) (i.e., AIFS[AC]) has elapsed. When transmitted by the QoS STA, any of the data frame, the management frame, and the control frame, which is not the response frame, may use the AIFS[AC] of the AC of the transmitted frame.

A WLAN device 104 may perform a backoff procedure when the WLAN device 104 that is ready to transfer a frame finds the medium busy. The backoff procedure includes determining a random backoff time composed of N backoff slots, where each backoff slot has a duration equal to a slot time and N being an integer number greater than or equal to zero. The backoff time may be determined according to a length of a Contention Window (CW). In an embodiment, the backoff time may be determined according to an AC of the frame. All backoff slots occur following a DIFS or Extended IFS (EIFS) period during which the medium is determined to be idle for the duration of the period.

When the WLAN device 104 detects no medium activity for the duration of a particular backoff slot, the backoff procedure shall decrement the backoff time by the slot time. When the WLAN device 104 determines that the medium is busy during a backoff slot, the backoff procedure is suspended until the medium is again determined to be idle for the duration of a DIFS or EIFS period. The WLAN device 104 may perform transmission or retransmission of the frame when the backoff timer reaches zero.

The backoff procedure operates so that when multiple WLAN devices 104 are deferring and execute the backoff procedure, each WLAN device 104 may select a backoff time using a random function and the WLAN device 104 that selects the smallest backoff time may win the contention, reducing the probability of a collision.

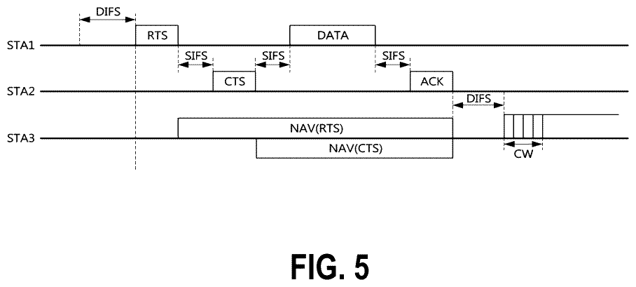

FIG. 5 illustrates a Carrier Sense Multiple Access/Collision Avoidance (CSMA/CA) based frame transmission procedure for avoiding collision between frames in a channel according to an embodiment. FIG. 5 shows a first station STA1 transmitting data, a second station STA2 receiving the data, and a third station STA3 that may be located in an area where a frame transmitted from the STA1 can be received, a frame transmitted from the second station STA2 can be received, or both can be received. The stations STA1, STA2, and STA3 may be WLAN devices 104 of FIG. 1.

The station STA1 may determine whether the channel is busy by carrier sensing. The station STA1 may determine channel occupation/status based on an energy level in the channel or an autocorrelation of signals in the channel, or may determine the channel occupation by using a network allocation vector (NAV) timer.

After determining that the channel is not used by other devices (that is, that the channel is IDLE) during a DIFS (and performing backoff if required), the station STA1 may transmit a Request-To-Send (RTS) frame to the station STA2. Upon receiving the RTS frame, after a SIFS the station STA2 may transmit a Clear-To-Send (CTS) frame as a response to the RTS frame. If Dual-CTS is enabled and the station STA2 is an AP, the AP may send two CTS frames in response to the RTS frame (e.g., a first CTS frame in a non-High Throughput format and a second CTS frame in the HT format).

When the station STA3 receives the RTS frame, it may set a NAV timer of the station STA3 for a transmission duration of subsequently transmitted frames (for example, a duration of SIFS+CTS frame duration+SIFS+data frame duration+SIFS+ACK frame duration) using duration information included in the RTS frame. When the station STA3 receives the CTS frame, it may set the NAV timer of the station STA3 for a transmission duration of subsequently transmitted frames using duration information included in the CTS frame. Upon receiving a new frame before the NAV timer expires, the station STA3 may update the NAV timer of the station STA3 by using duration information included in the new frame. The station STA3 does not attempt to access the channel until the NAV timer expires.

When the station STA1 receives the CTS frame from the station STA2, it may transmit a data frame to the station STA2 after a SIFS period elapses from a time when the CTS frame has been completely received. Upon successfully receiving the data frame, the station STA2 may transmit an ACK frame as a response to the data frame after a SIFS period elapses.

When the NAV timer expires, the third station STA3 may determine whether the channel is busy using the carrier sensing. Upon determining that the channel is not used by other devices during a DIFS period after the NAV timer has expired, the station STA3 may attempt to access the channel after a contention window elapses according to a backoff process.

When Dual-CTS is enabled, a station that has obtained a transmission opportunity (TXOP) and that has no data to transmit may transmit a CF-End frame to cut short the TXOP. An AP receiving a CF-End frame having a Basic Service Set Identifier (BSSID) of the AP as a destination address may respond by transmitting two more CF-End frames: a first CF-End frame using Space Time Block Coding (STBC) and a second CF-End frame using non-STBC. A station receiving a CF-End frame resets its NAV timer to 0 at the end of the PPDU containing the CF-End frame. FIG. 5 shows the station STA2 transmitting an ACK frame to acknowledge the successful reception of a frame by the recipient.

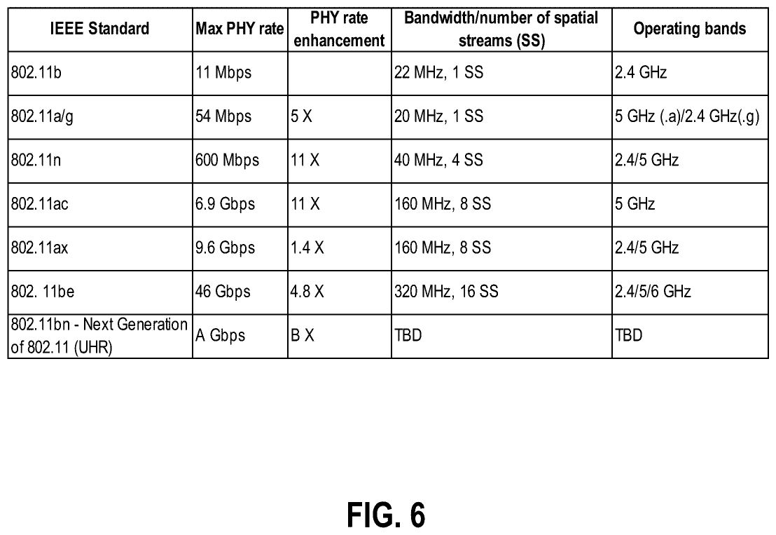

The IEEE 802.11bn (Ultra High Reliability, UHR) working group has been established to address the growing demand for higher peak throughput and reliability in Wi-Fi. As shown in FIG. 6, the peak PHY rate has significantly increased from IEEE 802.11b to IEEE 802.11be (Wi-Fi 7), with the latter focusing on further improving peak throughput. The UHR study group aims to enhance the tail of the latency distribution and jitter to support applications that require low latency, such as video-over-WLAN, gaming, AR, and VR. It is noted that various characteristics of UHR (e.g., max PHY rate, PHY rate enhancement, bandwidth/number of spatial streams, and operating bands) are still to be determined.

The focus of IEEE 802.11be is primarily on WLAN indoor and outdoor operation with stationary and pedestrian speeds in the 2.4, 5, and 6 GHz frequency bands. In addition to peak PHY rate, different candidate features are under discussion. These candidate features include (1) a 320 MHz bandwidth and a more efficient utilization of a non-contiguous spectrum, (2) multi-band/multi-channel aggregation and operation, (3) 16 spatial streams and Multiple Input Multiple Output (MIMO) protocol enhancements, (4) multi-Access Point (AP) Coordination (e.g., coordinated and joint transmission), (5) an enhanced link adaptation and retransmission protocol (e.g., Hybrid Automatic Repeat Request (HARQ)), and (6) adaptation to regulatory rules specific to a 6 GHz spectrum.

The focus of IEEE 802.11bn (UHR) is still under discussion, with candidate features including MLO enhancements (e.g., in terms of increased throughput/reliability and decreased latency), latency and reliability improvements (e.g., multi-AP coordination to support low latency traffic), bandwidth expansion (e.g., to 240, 480, 640 MHz), aggregated PPDU (A-PPDU), enhanced multi-link single-radio (eMLSR) extensions to AP, roaming improvements, and power-saving schemes for prolonging battery life.

Some features, such as increasing the bandwidth and the number of spatial streams, are solutions that have been proven to be effective in previous projects focused on increasing link throughput and on which feasibility demonstration is achievable.

With respect to operational bands (e.g., 2.4/5/6 GHz) for IEEE 802.11be, more than 1 GHz of additional unlicensed spectrum is likely to be available because the 6 GHz band (5.925-7.125 GHz) is being considered for unlicensed use. This would allow APs and STAs to become tri-band devices. Larger than 160 MHz data transmissions (e.g., 320 MHz or 640 MHz) could be considered to increase the maximum PHY rate. For example, 320 MHz or 160+160 MHz data could be transmitted in the 6 GHz band. For example, 160+160 MHz data could be transmitted across the 5 and 6 GHz bands.

In the process of wireless communication, a transmitting station (STA) creates a Physical Layer Protocol Data Unit (PPDU) frame and sends it to a receiving STA. The receiving STA then receives, detects, and processes the PPDU.

The Extremely High Throughput (EHT) PPDU frame encompasses several components. It includes a legacy part, which comprises fields such as the Legacy Short Training Field (L-STF), Legacy Long Training Field (L-LTF), Legacy Signal Field (L-SIG), and Repeated Legacy Signal Field (RL-SIG). These fields are used to maintain compatibility with older Wi-Fi standards.

In addition to the legacy part, the EHT PPDU frame also contains the Universal Signal Field (U-SIG), EHT Signal Field (EHT-SIG), EHT Short Training Field (EHT-STF), and EHT Long Training Field (EHT-LTF). These fields are specific to the EHT standard and are used for various purposes, such as signaling, synchronization, and channel estimation.

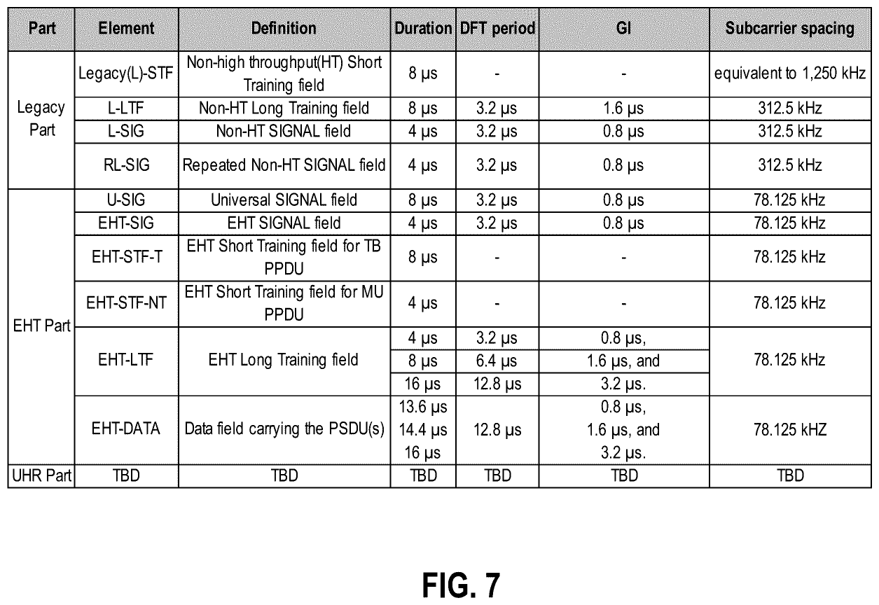

FIG. 7 provides a more detailed description of each field in the EHT PPDU frame, including their purposes and characteristics.

Regarding the Ultra High Reliability (UHR) PPDU, its frame structure is currently undefined and will be determined through further discussions within the relevant working group or study group. This indicates that the specifics of the UHR PPDU are still under development and will be finalized based on the outcomes of future deliberations.

The distributed nature of channel access networks, such as IEEE 802.11 WLANs, makes the carrier sense mechanism useful for ensuring collision-free operation. Each station (STA) uses its physical carrier sense to detect transmissions from other STAs. However, in certain situations, it may not be possible for a STA to detect every transmission. For instance, when one STA is located far away from another STA, it might perceive the medium as idle and start transmitting a frame, leading to collisions. To mitigate this hidden node problem, the network allocation vector (NAV) has been introduced.

As the IEEE 802.11 standard continues to evolve, it now includes scenarios where multiple users can simultaneously transmit or receive data within a basic service set (BSS), such as uplink (UL) and downlink (DL) multi-user (MU) transmissions in a cascaded manner. In these cases, the existing carrier sense and NAV mechanisms may not be sufficient, and modifications or newly defined mechanisms may be required to facilitate efficient and collision-free operation.

For the purpose of this disclosure, MU transmission refers to situations where multiple frames are transmitted to or from multiple STAs simultaneously using different resources. Examples of these resources include different frequency resources in Orthogonal Frequency Division Multiple Access (OFDMA) transmission and different spatial streams in Multi-User Multiple Input Multiple Output (MU-MIMO) transmission. Consequently, downlink OFDMA (DL-OFDMA), downlink MU-MIMO (DL-MU-MIMO), uplink OFDMA (UL-OFDMA), uplink MU-MIMO (UL-MU-MIMO), and OFDMA with MU-MIMO are all considered examples of MU transmission.

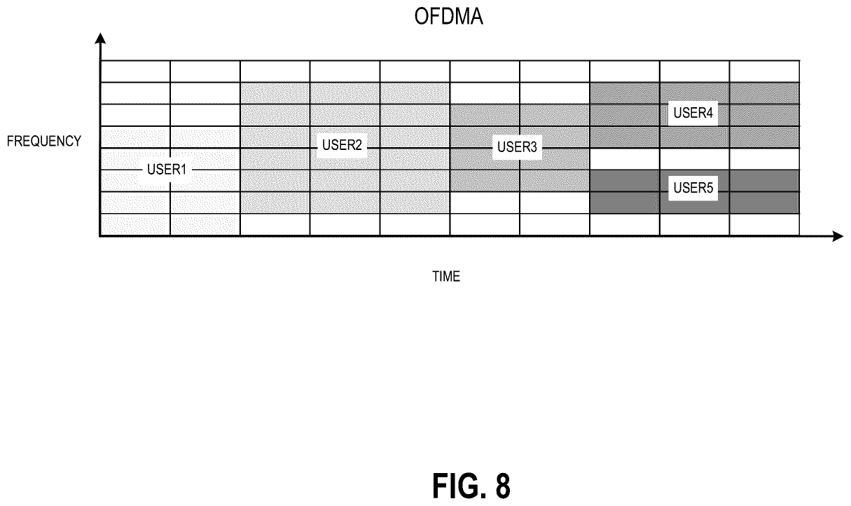

FIG. 8 illustrates an example of multi-user (MU) transmission in Orthogonal Frequency-Division Multiple Access (OFDMA), in accordance with some embodiments of the present disclosure.

In the IEEE 802.11ax and 802.11be specifications, the trigger frame plays a useful role in facilitating uplink multi-user (MU) transmissions. The purpose of the trigger frame is to allocate resources and solicit one or more Trigger-based (TB) Physical Layer Protocol Data Unit (PPDU) transmissions from the associated stations (STAs).

The trigger frame contains information required by the responding STAs to send their Uplink TB PPDUs. This information includes the Trigger type, which specifies the type of TB PPDU expected, and the Uplink Length (UL Length), which indicates the duration of the uplink transmission.

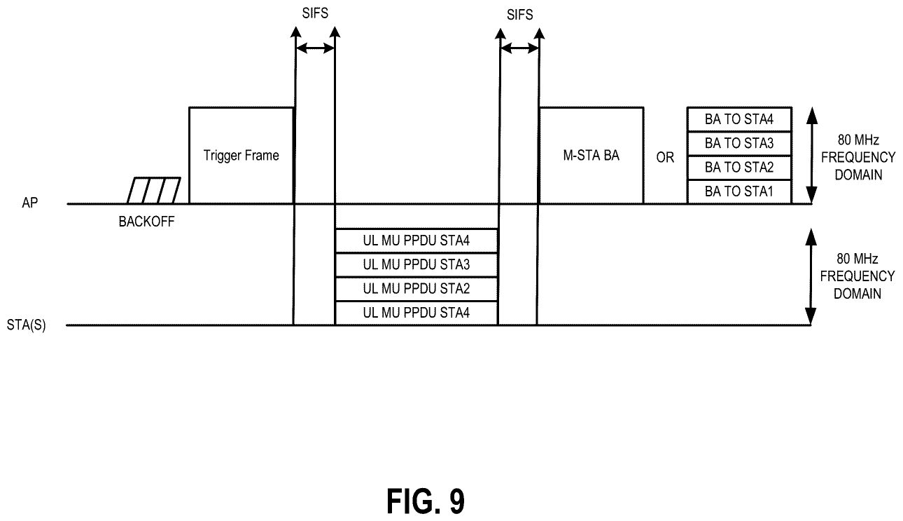

FIG. 9 illustrates an example scenario where an access point (AP) operating in an 80 MHz bandwidth environment sends a Trigger frame to multiple associated STAs. Upon receiving the Trigger frame, the STAs respond by sending their respective Uplink Orthogonal Frequency Division Multiple Access (UL OFDMA) TB PPDUs, utilizing the allocated resources within the specified 80 MHz bandwidth.

After successfully receiving the UL OFDMA TB PPDUs, the AP acknowledges the STAs by sending an acknowledgement frame. This acknowledgement can be in the form of an 80 MHz width multi-STA Block Acknowledgement (Block Ack) or a Block Acknowledgement with a Direct Feedback (DF) OFDMA method. The multi-STA Block Ack allows the AP to acknowledge multiple STAs simultaneously, while the Block Ack with DF OFDMA enables the AP to provide feedback to the STAs using the same OFDMA technique employed in the uplink transmission.

The trigger frame is a useful component in enabling efficient uplink MU transmissions in IEEE 802.11ax and 802.11be networks, by allocating resources and coordinating the uplink transmissions from multiple STAs within the same bandwidth.

Wireless network systems can rely on retransmission of media access control (MAC) protocol data units (MPDUs) when the transmitter (TX) does not receive an acknowledgement from the receiver (RX) or MPDUs are not successfully decoded by the receiver. Using an automatic repeat request (ARQ) approach, the receiver discards the last failed MPDU before receiving the newly retransmitted MPDU. With requirements of enhanced reliability and reduced latency, the wireless network system can evolve toward a hybrid ARQ (HARQ) approach.

There are two methods of HARQ processing. In a first type of HARQ scheme, also referred to as chase combining (CC) HARQ (CC-HARQ) scheme, signals to be retransmitted are the same as the signals that previously failed because all subpackets to be retransmitted use the same puncturing pattern. The puncturing is needed to remove some of the parity bits after encoding using an error-correction code. The reason why the same puncturing pattern is used with CC-HARQ is to generate a coded data sequence with forward error correction (FEC) and to make the receiver use a maximum-ratio combining (MRC) to combine the received, retransmitted bits with the same bits from the previous transmission. For example, information sequences are transmitted in packets with a fixed length. At a receiver, error correction and detection are carried out over the whole packet. However, the ARQ scheme may be inefficient in the presence of burst errors. To solve this more efficiently, subpackets are used. In subpacket transmissions, only those subpackets that include errors need to be retransmitted.

Since the receiver uses both the current and the previously received subpackets for decoding data, the error probability in decoding decreases as the number of used subpackets increases. The decoding process passes a cyclic redundancy check (CRC) and ends when the entire packet is decoded without error or the maximum number of subpackets is reached. In particular, this scheme operates on a stop-and-wait protocol such that if the receiver can decode the packet, it sends an acknowledgement (ACK) to the transmitter. When the transmitter receives an ACK successfully, it terminates the HARQ transmission of the packet. If the receiver cannot decode the packet, it sends a negative acknowledgement (NAK) to the transmitter and the transmitter performs the retransmission process.

In a second type of HARQ scheme, also referred to as an incremental redundancy (IR) HARQ (IR-HARQ) scheme, different puncturing patterns are used for each subpacket such that the signal changes for each retransmitted subpacket in comparison to the originally transmitted subpacket. IR-HARQ alternatively uses two puncturing patterns for odd numbered and even numbered transmissions, respectively. The redundancy scheme of IR-HARQ improves the log likelihood ratio (LLR) of parity bit(s) in order to combine information sent across different transmissions due to requests and lowers the code rate as the additional subpacket is used. This results in a lower error rate of the subpacket in comparison to CC-HARQ. The puncturing pattern used in IR-HARQ is indicated by a subpacket identity (SPID) indication. The SPID of the first subpacket may always be set to 0 and all the systematic bits and the punctured parity bits are transmitted in the first subpacket. Self-decoding is possible when the receiving signal-to-noise ratio (SNR) environment is good (i.e., a high SNR). In some embodiments, subpackets with corresponding SPIDs to be transmitted are in increasing order of SPID but can be exchanged/switched except for the first SPID.

AP coordination has been considered as a potential technology to improve WLAN system throughput in the IEEE 802.11be standard and is still being discussed in the IEEE 802.11bn (UHR) standard. To support various AP coordination schemes, such as coordinated beamforming, OFDMA, TDMA, spatial reuse, and joint transmission, a predefined mechanism for APs is necessary.

In the context of coordinated TDMA (C-TDMA), the AP that obtains a transmit opportunity (TXOP) is referred to as the sharing AP. This AP initiates the AP coordination schemes to determine the AP candidate set by sending a frame, such as a Beacon frame or probe response frame, which includes information about the AP coordination scheme capabilities. The AP that participates in the AP coordination schemes after receiving the frame from the sharing AP is called the shared AP. The sharing AP is also known as the master AP or coordinating AP, while the shared AP is referred to as the slave AP or coordinated AP.

The operation of various AP coordination schemes has been discussed in the IEEE 802.11be and UHR standards:

Coordinated Beamforming (C-BF): Multiple APs transmit on the same frequency resource by coordinating and forming spatial nulls, allowing for simultaneous transmission from multiple APs.

Coordinated OFDMA (C-OFDMA): APs transmit on orthogonal frequency resources by coordinating and splitting the spectrum, enabling more efficient spectrum utilization.

Joint Transmission (JTX): Multiple APs transmit jointly to a given user simultaneously by sharing data between the APs.

Coordinated Spatial Reuse (C-SR): Multiple APs or STAs adjust their transmit power to reduce interference between APs.

By implementing these AP coordination schemes, WLAN systems can improve their overall throughput and efficiency by leveraging the cooperation between multiple APs.

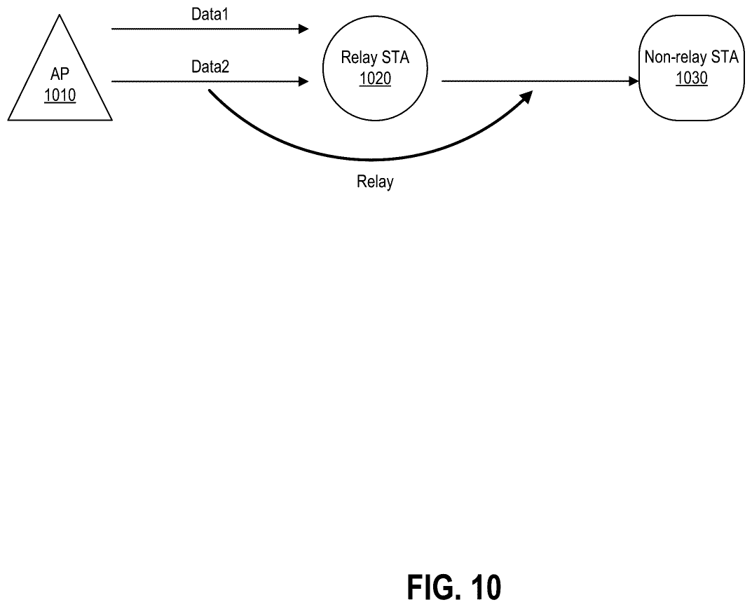

FIG. 10 is a diagram showing an example of a relayed downlink transmission, according to some embodiments. The relayed downlink transmission may involve an AP 1010, a relay STA 1020, and a non-relay STA 1030. The relay STA 1020 may act as a relay between the AP 1010 and the non-relay STA 1030.

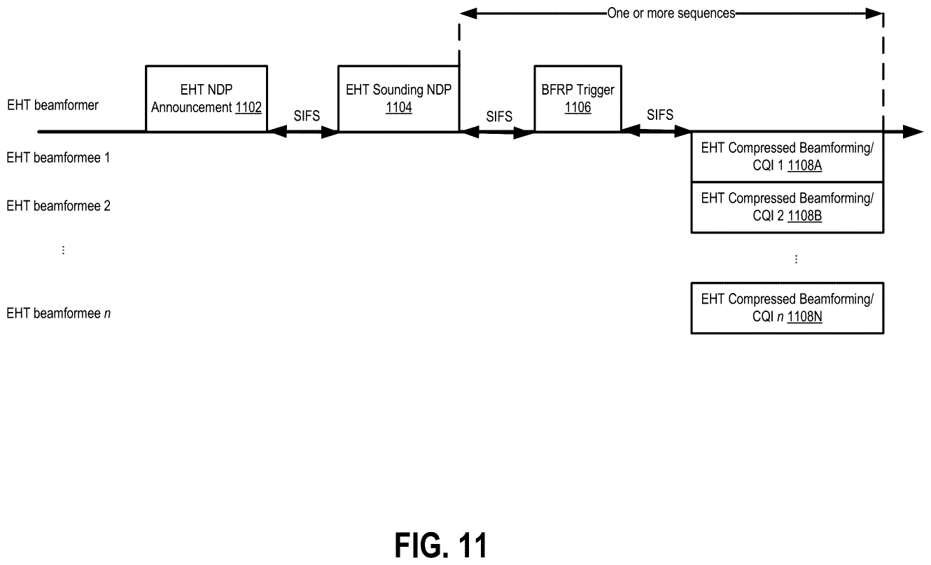

As shown in the diagram, an AP 1010 may transmit a first data frame (denoted as “Data 1” in the diagram) that is intended for the relay STA 1020 and a second data frame (denoted as “Data2” in the diagram) that is intended for the non-relay STA 1030. The relay STA 1020 may process the first data frame itself, but relay the second data frame from the AP 1010 to the non-relay STA 1030. It is assumed in this example that the relay STA 1020 and the non-relay STA 1030 have established a relay link. However, the relay operation may be transparent to the AP. That is, the AP may not be aware that the relay STA 1020 is acting as a relay to relay frames from the AP 1010 to the non-relay STA 1030. To further improve throughput, the AP may perform a beamformed transmission after performing a channel sounding process. An example channel sounding process is shown in FIG. 11 and described in further detail herein below.

FIG. 11 is a diagram showing an example of a channel sounding process involving multiple beamformees, according to some embodiments. The example channel sounding process shown in the diagram is an Extremely High Throughput (EHT) channel sounding process defined in the IEEE 802.11be wireless networking standard. While a particular channel sounding process is shown in the diagram, it should be appreciated that other channel sounding processes may be different from what is shown in the diagram. The channel sounding process shown in the diagram should thus be regarded as illustrative rather than restrictive.

The channel sounding process involves an EHT beamformer and multiple EHT beamformees (EHT beamformees 1-n). As shown in the diagram, the EHT beamformer may initiate the channel sounding process by transmitting an EHT NDP announcement frame 1102. Following a SIFS interval after transmitting the EHT NDP announcement frame 1102, the EHT beamformer may transmit a EHT sounding NDP frame 1104 to allow the EHT beamformees (EHT beamformees 1-n) to determine compressed beamforming (CBF) information and/or channel quality information (CQI). Following a SIFS interval after transmitting the EHT sounding NDP frame 1104, the EHT beamformer may transmit a beamforming report poll (BFRP) trigger frame 1106 to solicit EHT compressed beamforming/CQI report frames from the EHT beamformees. Responsive to receiving the BFRP trigger frame 1106, the EHT beamformees may each transmit an EHT compressed beamforming/CQI report frame 1108 to the EHT beamformer. For example, as shown in the diagram, EHT beamformee 1 may transmit EHT compressed beamforming/CQI report frame 1108A to the beamformer, EHT beamformee 2 may transmit EHT compressed beamforming/CQI report frame 1108B to the beamformer, and EHT beamformee n may transmit EHT compressed beamforming/CQI report frame 1108N to the beamformer. Each compressed beamforming/CQI report frame may include compressed beamforming information (e.g., phase (angle) information that can be used by the beamformer for beamforming) and/or CQI (e.g., which can be used by the beamformer for determining the modulation coding scheme (MCS) to use) determined by the beamformee. In MU-MIMO, a BFRP trigger frames and EHT compressed beamforming/CQI report frames may be exchanged once (e.g., as shown in the diagram) or multiple times until the beamformer obtains all of the necessary channel feedback information.

The type of channel feedback information that is provided by the EHT beamformees to the EHT beamformer in the EHT compressed beamforming/CQI report frames may be different depending on the type of transmission.

For beamformed transmission, the EHT beamformees may provide beamforming weights to the EHT beamformer, which the EHT beamformer can use to perform the beamformed transmission. Also, the EHT beamformees may provide the respective CQIs to the EHT beamformer.

For OFDMA transmission, the EHT beamformer may initiate a channel sounding process to determine which resource units (RUs) to allocate to the different beamformees in the MU transmission, as well as the settings to use for the MU transmission (e.g., the modulation coding scheme (MCS), the number of spatial streams (Nss), etc.). The EHT beamformees may provide CQI for the requested RUs and/or the entire bandwidth.

FIG. 12 is a diagram showing a format of a NDP announcement frame, according to some embodiments. The example format shown in the diagram is a format of an EHT NDP announcement frame defined in the IEEE 802.11be wireless networking standard. While a particular NDP announcement frame format is shown in the diagram, it should be appreciated that an NDP announcement frame can have a different format than what is shown in the diagram (e.g., omit some fields, have additional fields, have a different ordering of fields, etc.). The format shown in the diagram should thus be regarded as illustrative rather than restrictive.

As shown in the diagram, the EHT NDP announcement frame includes a frame control field 1202 (2 octets), a duration field 1204 (2 octets), a receiver address (RA) field 1206 (6 octets), a transmitter address (TA) field 1208 (6 octets), a sounding dialog token field 1210 (1 octet), a STA info list field 1212 (n×4 octets, where n is the number of STA info fields included in the STA info list field 1212), and a FCS field 1214 (4 octets).

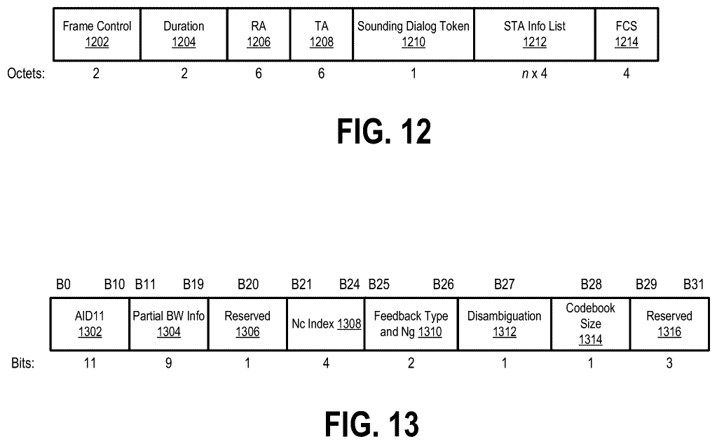

FIG. 13 is a diagram showing a format of a STA info field, according to some embodiments. The example format shown in the diagram is a format of a STA info field included in a STA info list field of an EHT NDP announcement frame defined in the IEEE 802.11be wireless networking standard. While a particular STA info field format is shown in the diagram, it should be understood that a STA info field can have a different format than what is shown in the diagram (e.g., omit some fields, have additional fields, have a different ordering of fields, etc.). The format shown in the diagram should thus be regarded as illustrative rather than restrictive.

A STA info list field may include multiple STA info fields, one for each STA that is to participate in the channel sounding process. As shown in the diagram, the STA info field may include an AID11 (association ID) field 1302 (11 bits), a partial bandwidth (BW) info field 1304 (9 bits), a reserved field 1306 (1 bit), a Nc index field 1308 (4 bits), a feedback type and Ng field 1310 (2 bits), a disambiguation field 1312 (1 bit), a codebook size field 1314 (1 bit), and another reserved field 1316 (3 bits). The bit positions of the fields may be as shown in the diagram. The STA info field may indicate the type and bandwidth for the compressed beamforming information and/or CQI being requested by the beamformer (e.g., the type can be indicated in the feedback type and Ng field 1310 and the bandwidth can be indicated in the partial BW info field 1304).

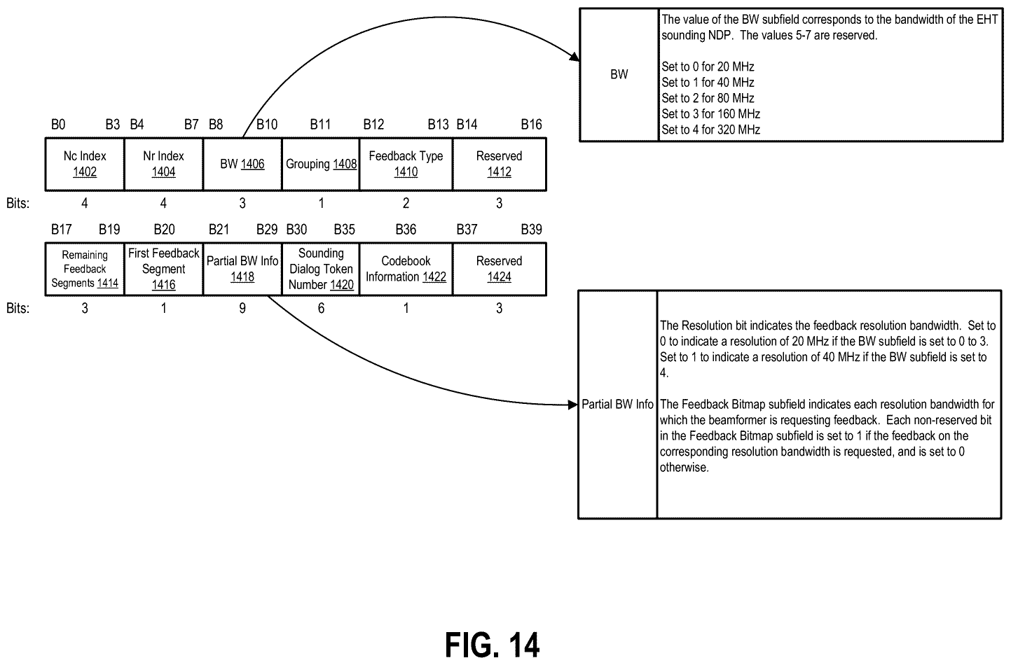

FIG. 14 is a diagram showing a format of a MIMO control field included in a compressed beamforming/CQI report frame, according to some embodiments. The example format shown in the diagram is a format of a MIMO control field included in an EHT compressed beamforming/CQI report frame defined in the IEEE 802.11be wireless networking standard. While a particular MIMO control field format is shown in the diagram, it should be understood that a MIMO control field can have a different format than what is shown in the diagram (e.g., omit some fields, have additional fields, have a different ordering of fields, etc.). The format shown in the diagram should thus be regarded as illustrative rather than restrictive.

As shown in the diagram, the MIMO control field includes a Nc index field 1402 (4 bits), a Nr index field 1404 (4 bits), a bandwidth (BW) field 1406 (3 bits), a grouping field 1408 (1 bit), a feedback type field 1410 (2 bits), a reserved field 1412 (3 bits), a remaining feedback segments field 1414 (3 bits), a first feedback segment field 1416 (1 bit), a partial BW info field (9 bits), a sounding dialog token number field 1420 (6 bits), a codebook information field 1422 (1 bit), and another reserved field 1424 (3 bits).

The diagram also shows details of the BW field 1406 and the partial BW info field 1418. As shown in the diagram, the value of the BW field 1406 may correspond to the bandwidth of the EHT sounding NDP frame. The value of the BW field 1406 may be set to 0 to indicate a bandwidth of 20 MHz, set to 1 to indicate a bandwidth of 40 MHz, set to 2 to indicate a bandwidth of 80 MHz, set to 3 to indicate a bandwidth of 160 MHz, and set to 4 to indicate a bandwidth of 320 MHz. The partial BW info field 1418 may include a resolution bit and a feedback bitmap (sub)field. The resolution bit may indicate the feedback resolution bandwidth. The value of the resolution bit may be set to 0 to indicate a resolution of 20 MHz if the value of the BW field 1406 is set to 0 to 3. The value of the resolution bit may be set to 1 to indicate a resolution of 40 MHz if the value of the BW field 1406 is set to 4. The feedback bitmap field may indicate each resolution bandwidth for which the beamformer is requesting feedback. Each non-reserved bit in the feedback bitmap (sub)field may be set to 1 if the feedback on the corresponding resolution bandwidth is requested, and may be set to 0 otherwise.

A beamformee may transmit a compressed beamforming/CQI report frame to the beamformer to provide the requested compressed beamforming information and/or CQI to the beamformer. The MIMO control field included in the compressed beamforming/CQI report frame may indicate the type and bandwidth for the compressed beamforming information and/or CQI being provided by the beamformee to the beamformer.

After performing the channel sounding process, the beamformer may calculate the MU-MIMO beamforming matrix that minimizes inter-beamformee interference and maximizes the throughput. The beamformer may then transmit data frames to the multiple beamformees in a beamformed manner using the calculated beamforming matrix.

In the example network configuration shown in in FIG. 10, the AP 1010 (operating as the beamformer) may initiate the channel sounding process to obtain channel feedback information (e.g., compressed beamforming information and/or CQI) from the relay STA 1020 and the non-relay STA 1030 (operating as beamformees). If the AP 1010 requests feedback of channel information from both the relay STA 1020 and the non-relay STA 1030 (e.g., by including STA info fields for the relay STA 1020 and the non-relay STA 1030 in the STA info list field of the NDP announcement frame), the relay STA 1020 may respond to the request by providing channel feedback information for both the relay STA 1020 and the non-relay STA 1030 to the AP 1010 because the relay STA 1020 relays the data frames intended for the non-relay STA 1030 (e.g., Data2 shown in FIG. 10). As a result, the feedback channel information for both the relay STA 1020 and the non-relay STA 1030 may be identical. This means that the AP 1010 cannot properly determine the MU-MIMO beamforming matrix to minimize the inter-STA interference.

In the relay operation scenario described above, it would be better for the AP 1010 to transmit data to the relay STA 1020 and the non-relay STA 1030 using different frequency resources (different partial bandwidths) in an OFDMA manner. However, the AP 1010 requests feedback of channel information (e.g., compressed beamforming information and/or CQI) for a MU-MIMO transmission because the AP 1010 does not recognize the existence of the relay operation. With the existing channel sounding process, the beamformer, and not the beamformee, is the one that decides and indicates the partial bandwidth that is to be used by the beamformees. Thus, in this example, this means that the AP 1010 (which operates as the beamformer) decides the type of channel feedback information that is to be provided and the relay STA 1020 (as well as non-relay STA 1030, which operate as beamformees) should follow the decision of the AP 1010.

To address this problem, embodiments allow a beamformee (e.g., relay STA 1020 shown in FIG. 10) to set the partial bandwidth information included in the MIMO control field of the compressed beamforming/CQI report frame to be different from the partial bandwidth information indicated in the NDP announcement frame. This allows the beamformee to inform the beamformer (e.g., AP 1010 shown in FIG. 10) that different partial bandwidths (e.g., that are within the partial bandwidth indicated by the beamformer) should be used for transmitting data frames to different beamformees (e.g., in FIG. 10, Data1 (intended for the non-relay STA 1030) should be transmitted using one partial bandwidth within the partial bandwidth indicated by the AP 1010 and Data2 (intended for the relay STA 1020) should be transmitted using another partial bandwidth within the partial bandwidth indicated by the AP). To allow for such operation, the format of a MIMO control field can be modified, as will be described herein below. The modified MIMO control field may be used in next generation wireless networks (e.g., wireless networks that are to implement the IEEE 802.11bn wireless networking standard) to enable the functionality described herein.

In an embodiment, one of the reserved bits included in the MIMO control field (e.g., any one of bits B14-B16 and B37-B39 of the first MIMO control field) is used to indicate a change in partial bandwidth for a beamformee relative to the partial bandwidth that was indicated by the beamformer in the NDP announcement frame. Such bit may be referred to herein as a partial bandwidth change indication bit. If a beamformee determines that the beamformer should use a partial bandwidth that is different from the partial bandwidth that was indicated by the beamformer in the NDP announcement frame, the beamformee may obtain channel feedback information (e.g., compressed beamforming information and/or CQI) for the different partial bandwidth and transmit a MIMO control field (e.g., as part of a compressed beamforming/CQI report frame) to the beamformer in which the partial bandwidth change indication bit indicates that there is a change in partial bandwidth. The MIMO control field may also indicate the different partial bandwidth to be used. In an embodiment, the partial bandwidth change indication bit is set to a value of ‘1’ to indicate there is a change in the partial bandwidth and the partial bandwidth change indication bit is set to a value of ‘0’ to indicate there is no change in the partial bandwidth (although it should be appreciated that the opposite convention is also possible). After receiving such a modified MIMO control field, the beamformer may transmit data to the beamformee using the different partial bandwidth indicated in the MIMO control field received from the beamformee.

In the relay operation scenario shown in FIG. 10, the relay STA 1020 (operating as a beamformee) may transmit a MIMO control field for itself and a MIMO control field for the non-relay STA 1030 to the AP 1010 (operating as a beamformer). Each MIMO control field may indicate a different partial bandwidth within the partial bandwidth that was indicated by the AP 1010 in the NDP announcement frame. Upon receiving the MIMO control fields, the AP 1010 may transmit Data1 (intended for relay STA 1020) and Data2 (intended for non-relay STA 1030) using the (different/modified) partial bandwidths indicated in the respective MIMO control fields. As a result, Data1 and Data2 may be transmitted in an OFDMA manner.

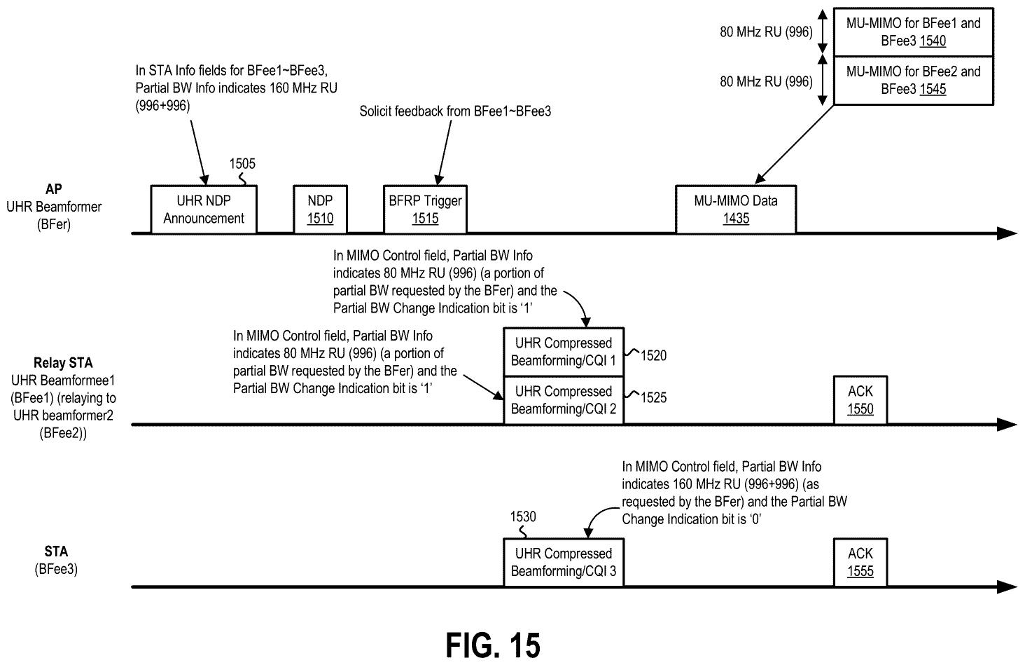

FIG. 15 is a diagram showing an example of a channel sounding process and a MU-MIMO transmission, according to some embodiments.

The channel sounding process may involve an AP, a relay STA, and a STA. In this example, the AP (e.g., a UHR AP) may operate as a beamformer, while the relay STA (e.g., a UHR STA) and the STA operate as beamformees. The relay STA may act as a relay between the AP and a non-relay STA. The non-relay STA may also operate as a beamformee. Thus, in this example, there may be three STAs operating as beamformees: the relay STA, the non-relay STA (to which the relay STA relays data to), and another STA (that is not involved in the relay operation). In this example, the relay STA may be referred to as beamformee1 (BFee1), the non-relay STA may be referred to as beamformee2 (BFee2), and the other STA may be referred to as beamformee3 (BFee3).

As shown in the diagram, the AP (operating as a beamformer) may transmit a UHR NDP announcement frame 1505. The UHR NDP announcement frame 1505 may include STA info fields for the relay STA, the non-relay STA, and the other STA (beamformees1-3). Each STA info field may include a partial BW info field indicating the same 160 MHz bandwidth/RU (996+996 tones). The AP may then transmit a NDP frame 1510 followed by the BFRP trigger frame 1515 to solicit UHR compressed beamforming/CQI report frames from the relay STA (beamformee1), the non-relay STA (beamformee2), and the other STA (beamformee3).

Responsive to receiving BFRP trigger frame 1515, the relay STA may transmit UHR compressed beamforming/CQI report frame 1520 and UHR compressed beamforming/CQI report frame 1525 to the beamformer. UHR compressed beamforming/CQI report frame 1520 may include channel feedback information for the relay STA (beamformee1) and UHR compressed beamforming/CQI report frame 1525 may include channel feedback information for the non-relay STA (beamformee2). UHR compressed beamforming/CQI report frame 1520 and UHR compressed beamforming/CQI report frame 1525 may each include a MIMO control field that includes a partial bandwidth change indication bit that is set to ‘1’ (to indicate there is a change in partial bandwidth) and a partial BW info field that indicates a distinct 80 MHz bandwidth/RU (966 tones) within the 160 MHz RU that was indicated in the UHR NDP announcement frame 1505. Also, responsive to receiving BFRP trigger frame 1515, the other STA (beamformee3) may transmit UHR compressed beamforming/CQI report frame 1530 to the beamformer. UHR compressed beamforming/CQI report frame 1530 may include channel feedback information for the other STA (beamformee3). UHR compressed beamforming/CQI report frame 1530 may include a MIMO control field that includes a partial bandwidth change indication bit that is set to ‘0″ (to indicate there is no change in partial bandwidth) and a partial BW info field that indicates the same 160 MHz bandwidth/RU (996+996 tones) that was indicated in the UHR NDP announcement frame 1505.

Responsive to receiving the UHR compressed beamforming/CQI report frames 1520, 1525, and 1530, the AP may transmit a MU-MIMO data frame 1435 occupying a 160 MHz bandwidth, in which an 80 MHz bandwidth is used for transmitting data 1540 intended for the relay STA (beamformee 1) and the other STA (beamformee 3) and the other 80 MHz bandwidth is used for transmitting data 1545 intended for the non-relay STA (beamformee 2) and the other STA (beamformee 3). The relay STA (beamformee3) and the other STA (beamformee3) may transmit ACK frame 1550 and ACK frame 1555, respectively, to the AP if they successfully receive the data.

In this manner, the relay STA may inform the AP that the AP should use different partial bandwidths than what was indicated in the UHR NDP announcement frame to allow for more efficient transmission in the relay operation scenario. While such technique for changing the partial bandwidth is suitable for use in relay operation scenarios, it should be appreciated that the technique is not restricted to being used in relay operation scenarios and can be applied in other scenarios. For example, the technique for changing the partial bandwidth described herein may be used in a situation where there is a device near a beamformee that is causing significant interference and the beamformer is unaware of this interference. The interference may corrupt a part of the bandwidth (e.g., the bandwidth indicated in the NDP announcement frame) at the beamformee side. Thus, the beamformee may decide not to use the corrupted part of the bandwidth. The beamformee may use the technique described herein to inform the beamformer to change the partial bandwidth so as not to use the corrupted part of the bandwidth. Also, while an embodiment is shown and described in which the partial bandwidth change indication bit is included in the MIMO control field, the partial bandwidth change indication bit may be located elsewhere (e.g., in a different field) in other embodiments. In an embodiment, the NDP announcement frame includes a bit to indicate whether the beamformee is allowed to change the partial bandwidth. If this bit indicates that the beamformee is allowed to change the partial bandwidth, then the beamformee may change the partial bandwidth, as described herein. Otherwise, if this bit indicates that the beamformee is not allowed to change the partial bandwidth, then the beamformee should use the same partial bandwidth that was indicated in the NDP announcement frame.

In an embodiment, if a beamformer receives the same compressed beamforming information and/or CQI information from multiple beamformees, the beamformer transmits data to the beamformees in an aggregated format such as in an aggregated PPDU. The aggregated PPDU may include multiple sub-PPDUs each having a different beamformee as its destination. In this case, the beamformees may provide compressed beamforming information and/or CQI to the beamformer for a wider bandwidth than the bandwidth that is actually used by the beamformer to transmit data to the beamformees. For example, the beamformees may provide compressed beamforming information and/or CQI for a 40 MHz bandwidth, but the beamformer may transmit data in a beamformed manner in a 20 MHz bandwidth.

The range-vs-rate performance can be improved by combining relay operations with beamformed transmission. However, as mentioned above, the existing channel sounding processes (e.g., the channel sounding process defined in existing IEEE 802.11be wireless networking standard) may not take relay operations into consideration, resulting in inefficient data transmission when relay operations are employed. The modified compressed beamforming/CQI report frame, along with the associated operations described herein, may be used to better support MU-MIMO transmission in a relay operation scenario. With embodiments, relay operation and beamformed transmission can be better combined to achieve improved range-vs-rate performance.

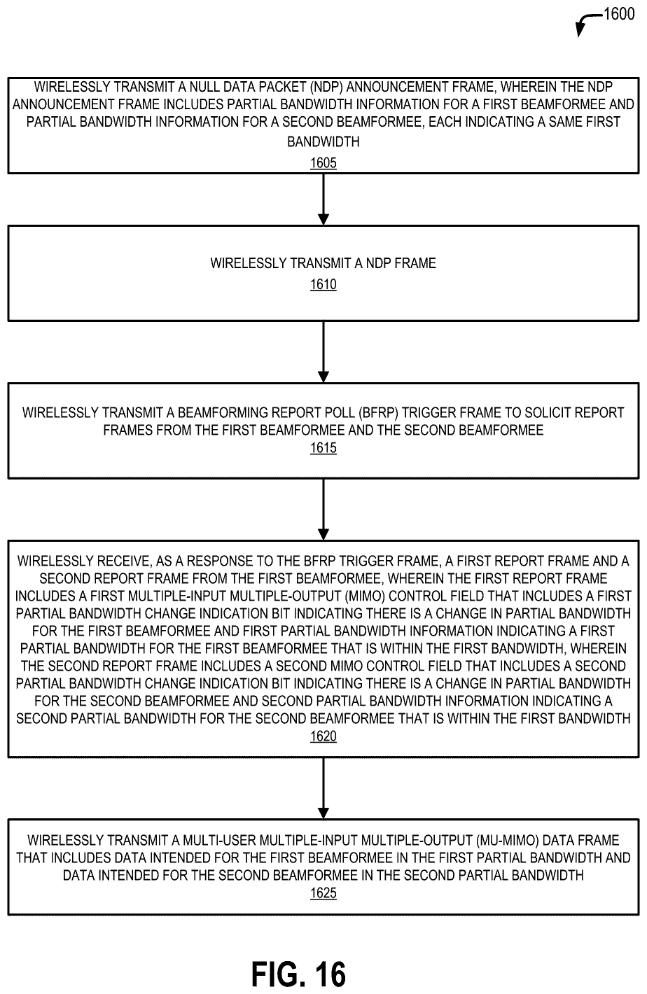

Turning now to FIG. 16, a method 1600 will be described for performing a channel sounding process, in accordance with an example embodiment. The method 1600 may be performed by a beamformer in a wireless network. The beamformer may be implemented by a wireless device (e.g., wireless device 104).

Additionally, although shown in a particular order, in some embodiments the operations of the method 1600 (and the other methods shown in the other figures) may be performed in a different order. For example, although the operations of the method 1600 are shown in a sequential order, some of the operations may be performed in partially or entirely overlapping time periods.

At operation 1605, the beamformer wirelessly transmits a NDP announcement frame, wherein the NDP announcement frame includes partial bandwidth information for a first beamformee and partial bandwidth information for a second beamformee, each indicating a same first bandwidth.

At operation 1610, the beamformer wirelessly transmits a NDP frame.

At operation 1615, the beamformer wirelessly transmits a BFRP trigger frame to solicit report frames (e.g., compressed beamforming/CQI report frames) from the first beamformee and the second beamformee.

At operation 1620, the beamformer wirelessly receives, as a response to the BFRP trigger frame, a first report frame and a second report frame from the first beamformee, wherein the first report frame includes a first MIMO control field that includes a first partial bandwidth change indication bit indicating there is a change in partial bandwidth for the first beamformee and first partial bandwidth information indicating a first partial bandwidth for the first beamformee that is within the first bandwidth, wherein the second report frame includes a second MIMO control field that includes a second partial bandwidth change indication bit indicating there is a change in partial bandwidth for the second beamformee and second partial bandwidth information indicating a second partial bandwidth for the second beamformee that is within the first bandwidth (the report frames may be compressed beamforming/CQI report frames). In an embodiment, the first partial bandwidth change indication bit is one of bits B14-B16 and B37-B39 of the first MIMO control field. In an embodiment, the first partial bandwidth change indication bit is set to ‘1’ to indicate there is the change in the partial bandwidth for the first beamformee, wherein the first partial bandwidth change indication bit being set to ‘0’ indicates there is no change in the partial bandwidth for the first beamformee. In an embodiment, the second partial bandwidth change indication bit is set to ‘1’ to indicate there is the change in the partial bandwidth for the second beamformee, wherein the second partial bandwidth change indication bit being set to ‘0’ indicates there is no change in the partial bandwidth for the second beamformee. In an embodiment, the first partial bandwidth information is included in a partial BW info field of the first MIMO control field and the second partial bandwidth information is included in a partial BW info field of the second MIMO control field. In an embodiment, the first bandwidth has a size of 160 MHz, the first partial bandwidth has a size of 80 MHz, and the second partial bandwidth has a size of 80 MHz. In an embodiment, the first report frame includes compressed beamforming information and/or CQI for the first partial bandwidth and the second report frame includes compressed beamforming information and/or CQI for the second partial bandwidth.

At operation 1625, the beamformer wirelessly transmits a MU-MIMO data frame that includes data intended for the first beamformee in the first partial bandwidth and data intended for the second beamformee in the second partial bandwidth.

In an embodiment, the beamformer wirelessly receives, as a response to the BFRP trigger frame, a third report frame from a third beamformee, wherein the third report frame includes a third MIMO control field that includes a third partial bandwidth change indication bit indicating there is no change in partial bandwidth for the third beamformee and third partial bandwidth information indicating the first bandwidth, wherein the MU-MIMO data frame further includes data intended for the third beamformee in the first bandwidth.

In an embodiment, the beamformer wirelessly receives a third report frame from a third beamformee and a fourth report frame from a fourth beamformee. Responsive to determining that the third report frame and the fourth report frame include a same compressed beamforming information and/or CQI, the beamformer may wirelessly transmit an aggregated PPDU that includes a sub-PPDU addressed to the third beamformee and a sub-PPDU addressed to the fourth beamformee.

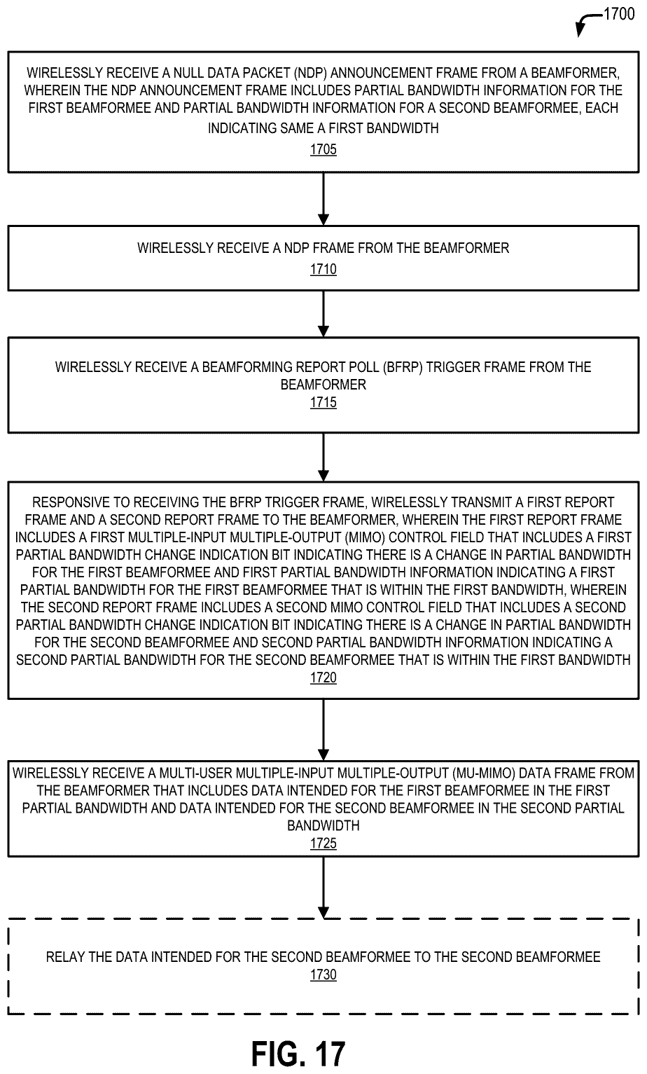

Turning now to FIG. 17, a method 1700 will be described for participating in a channel sounding process, in accordance with an example embodiment. The method 1700 may be performed by a first beamformee in a wireless network. The first beamformee may be implemented by a wireless device e.g., wireless device 104).

At operation 1705, the beamformee wirelessly receives a NDP announcement frame from a beamformer, wherein the NDP announcement frame includes partial bandwidth information for the first beamformee and partial bandwidth information for a second beamformee, each indicating a same first bandwidth.

At operation 1710, the beamformee wirelessly receives a NDP frame from the beamformer.

At operation 1715, the beamformee wirelessly receives a BFRP trigger frame from the beamformer.

At operation 1720, responsive to receiving the BFRP trigger frame, the beamformee wirelessly transmits a first report frame and a second report frame to the beamformer, wherein the first report frame includes a first MIMO control field that includes a first partial bandwidth change indication bit indicating there is a change in partial bandwidth for the first beamformee and first partial bandwidth information indicating a first partial bandwidth for the first beamformee that is within the first bandwidth, wherein the second report frame includes a second MIMO control field that includes a second partial bandwidth change indication bit indicating there is a change in partial bandwidth for the second beamformee and second partial bandwidth information indicating a second partial bandwidth for the second beamformee that is within the first bandwidth. In an embodiment, the first partial bandwidth change indication bit is one of bits B14-B16 and B37-B39 of the first MIMO control field. In an embodiment, the first partial bandwidth change indication bit is set to ‘1’ to indicate there is the change in the partial bandwidth for the first beamformee, wherein the first partial bandwidth change indication bit being set to ‘0’ indicates there is no change in the partial bandwidth for the first beamformee. In an embodiment, the second partial bandwidth change indication bit is set to ‘1’ to indicate there is the change in the partial bandwidth for the second beamformee, wherein the second partial bandwidth change indication bit being set to ‘0’ indicates there is no change in the partial bandwidth for the second beamformee. In an embodiment, the first partial bandwidth information is included in a partial BW info field of the first MIMO control field and the second partial bandwidth information is included in a partial BW info field of the second MIMO control field. In an embodiment, the first bandwidth has a size of 160 MHz, the first partial bandwidth has a size of 80 MHz, and the second partial bandwidth has a size of 80 MHz. In an embodiment, the first report frame includes compressed beamforming information and/or CQI for the first partial bandwidth and the second report frame includes compressed beamforming information and/or CQI for the second partial bandwidth.

At operation 1725, the beamformee wirelessly receives a MU-MIMO data frame from the beamformer that includes data intended for the first beamformee in the first partial bandwidth and data intended for the second beamformee in the second partial bandwidth.

In an embodiment, at operation 1730, the beamformee relays the data intended for the second beamformee to the second beamformee.

Although many of the solutions and techniques provided herein have been described with reference to a WLAN system, it should be understood that these solutions and techniques are also applicable to other network environments, such as cellular telecommunication networks, wired networks, etc. In some embodiments, the solutions and techniques provided herein may be or may be embodied in an article of manufacture in which a non-transitory machine-readable medium (such as microelectronic memory) has stored thereon instructions which program one or more data processing components (generically referred to here as a “processor” or “processing unit”) to perform the operations described herein. In other embodiments, some of these operations might be performed by specific hardware components that contain hardwired logic (e.g., dedicated digital filter blocks and state machines). Those operations might alternatively be performed by any combination of programmed data processing components and fixed hardwired circuit components.

In some cases, an embodiment may be an apparatus (e.g., an AP STA, a non-AP STA, or another network or computing device) that includes one or more hardware and software logic structures for performing one or more of the operations described herein. For example, as described herein, an apparatus may include a memory unit, which stores instructions that may be executed by a hardware processor installed in the apparatus. The apparatus may also include one or more other hardware or software elements, including a network interface, a display device, etc.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. For example, a computer system or other data processing system may carry out the computer-implemented methods described herein in response to its processor executing a computer program (e.g., a sequence of instructions) contained in a memory or other non-transitory machine-readable storage medium. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method performed by a first beamformee to participate in a channel sounding process, the method comprising:
wirelessly receiving a null data packet (NDP) announcement frame from a beamformer, wherein the NDP announcement frame includes partial bandwidth information for the first beamformee and partial bandwidth information for a second beamformee, each indicating a same first bandwidth;
wirelessly receiving a NDP frame from the beamformer;
wirelessly receiving a beamforming report poll (BFRP) trigger frame from the beamformer;
responsive to receiving the BFRP trigger frame, wirelessly transmitting a first report frame and a second report frame to the beamformer, wherein the first report frame includes a first multiple-input multiple-output (MIMO) control field that includes a first partial bandwidth change indication bit indicating there is a change in partial bandwidth for the first beamformee and first partial bandwidth information indicating a first partial bandwidth for the first beamformee that is within the first bandwidth, wherein the second report frame includes a second MIMO control field that includes a second partial bandwidth change indication bit indicating there is a change in partial bandwidth for the second beamformee and second partial bandwidth information indicating a second partial bandwidth for the second beamformee that is within the first bandwidth; and
wirelessly receiving a multi-user multiple-input multiple-output (MU-MIMO) data frame from the beamformer that includes data intended for the first beamformee in the first partial bandwidth and data intended for the second beamformee in the second partial bandwidth.

2. The method of claim 1, wherein the first partial bandwidth change indication bit is one of bits B14-B16 and B37-B39 of the first MIMO control field.

3. The method of claim 2, wherein the first partial bandwidth change indication bit is set to ‘1’ to indicate there is the change in the partial bandwidth for the first beamformee, wherein the first partial bandwidth change indication bit being set to ‘0’ indicates there is no change in the partial bandwidth for the first beamformee.

4. The method of claim 1, wherein the first bandwidth has a size of 160 Megahertz (MHz), the first partial bandwidth has a size of 80 MHz, and the second partial bandwidth has a size of 80 MHz.

5. The method of claim 1, wherein the first report frame includes compressed beamforming information and/or channel quality information (CQI) for the first partial bandwidth and the second report frame includes compressed beamforming information and/or CQI for the second partial bandwidth.

6. The method of claim 1, further comprising:
relaying the data intended for the second beamformee to the second beamformee.

7. A method performed by a beamformer to perform a channel sounding process, the method comprising:
wirelessly transmitting a null data packet (NDP) announcement frame, wherein the NDP announcement frame includes partial bandwidth information for a first beamformee and partial bandwidth information for a second beamformee, each indicating a same first bandwidth;
wirelessly transmitting a NDP frame;
wirelessly transmitting a beamforming report poll (BFRP) trigger frame to solicit report frames from the first beamformee and the second beamformee;
wirelessly receiving, as a response to the BFRP trigger frame, a first report frame and a second report frame from the first beamformee, wherein the first report frame includes a first multiple-input multiple-output (MIMO) control field that includes a first partial bandwidth change indication bit indicating there is a change in partial bandwidth for the first beamformee and first partial bandwidth information indicating a first partial bandwidth for the first beamformee that is within the first bandwidth, wherein the second report frame includes a second MIMO control field that includes a second partial bandwidth change indication bit indicating there is a change in partial bandwidth for the second beamformee and second partial bandwidth information indicating a second partial bandwidth for the second beamformee that is within the first bandwidth; and
wirelessly transmitting a multi-user multiple-input multiple-output (MU-MIMO) data frame that includes data intended for the first beamformee in the first partial bandwidth and data intended for the second beamformee in the second partial bandwidth.

8. The method of claim 7, wherein the first partial bandwidth change indication bit is one of bits B14-B16 and B37-B39 of the first MIMO control field.

9. The method of claim 8, wherein the first partial bandwidth change indication bit is set to ‘1’ to indicate there is the change in the partial bandwidth for the first beamformee, wherein the first partial bandwidth change indication bit being set to ‘0’ indicates there is no change in the partial bandwidth for the first beamformee.

10. The method of claim 7, wherein the first bandwidth has a size of 160 Megahertz (MHz), the first partial bandwidth has a size of 80 MHz, and the second partial bandwidth has a size of 80 MHz.

11. The method of claim 7, wherein the first report frame includes compressed beamforming information and/or channel quality information (CQI) for the first partial bandwidth and the second report frame includes compressed beamforming information and/or CQI for the second partial bandwidth.

12. The method of claim 7, wherein the first beamformee acts as a relay between the beamformer and the second beamformee.

13. The method of claim 7, further comprising:
wirelessly receiving, as a response to the BFRP trigger frame, a third report frame from a third beamformee, wherein the third report frame includes a third MIMO control field that includes a third partial bandwidth change indication bit indicating there is no change in partial bandwidth for the third beamformee and third partial bandwidth information indicating the first bandwidth, wherein the MU-MIMO data frame further includes data intended for the third beamformee in the first bandwidth.

14. The method of claim 7, further comprising:
wirelessly receiving a third report frame from a third beamformee and a fourth report frame from a fourth beamformee; and
responsive to determining that the third report frame and the fourth report frame include a same compressed beamforming information and/or channel quality information (CQI), wirelessly transmitting an aggregated physical layer protocol data unit (PPDU) that includes a sub-PPDU addressed to the third beamformee and a sub-PPDU addressed to the fourth beamformee.

15. A wireless device to implement a first beamformee, the wireless device comprising:
a radio frequency transceiver;
a memory device storing a set of instructions; and
a processor coupled to the memory device, wherein the set of instructions when executed by the processor causes the first beamformee to:
wirelessly receive a null data packet (NDP) announcement frame from a beamformer, wherein the NDP announcement frame includes partial bandwidth information for the first beamformee and partial bandwidth information for a second beamformee, each indicating a same first bandwidth;
wirelessly receive a NDP frame from the beamformer;
wirelessly receive a beamforming report poll (BFRP) trigger frame from the beamformer;
responsive to receiving the BFRP trigger frame, wirelessly transmit a first report frame and a second report frame to the beamformer, wherein the first report frame includes a first multiple-input multiple-output (MIMO) control field that includes a first partial bandwidth change indication bit indicating there is a change in partial bandwidth for the first beamformee and first partial bandwidth information indicating a first partial bandwidth for the first beamformee that is within the first bandwidth, wherein the second report frame includes a second MIMO control field that includes a second partial bandwidth change indication bit indicating there is a change in partial bandwidth for the second beamformee and second partial bandwidth information indicating a second partial bandwidth for the second beamformee that is within the first bandwidth; and
wirelessly receive a multi-user multiple-input multiple-output (MU-MIMO) data frame from the beamformer that includes data intended for the first beamformee in the first partial bandwidth and data intended for the second beamformee in the second partial bandwidth.

16. The wireless device of claim 15, wherein the first partial bandwidth change indication bit is one of bits B14-B16 and B37-B39 of the first MIMO control field.

17. The wireless device of claim 15, wherein the set of instructions when executed by the processor further causes the first beamformee to relay the data intended for the second beamformee to the second beamformee.

18. A wireless device to implement a beamformer, the wireless device comprising:
a radio frequency transceiver;
a memory device storing a set of instructions; and
a processor coupled to the memory device, wherein the set of instructions when executed by the processor causes the beamformer to:
wirelessly transmit a null data packet (NDP) announcement frame, wherein the NDP announcement frame includes partial bandwidth information for a first beamformee and partial bandwidth information for a second beamformee, each indicating a same first bandwidth;
wirelessly transmit a NDP frame;
wirelessly transmit a beamforming report poll (BFRP) trigger frame to solicit report frames from the first beamformee and the second beamformee;
wirelessly receive, as a response to the BFRP trigger frame, a first report frame and a second report frame from the first beamformee, wherein the first report frame includes a first multiple-input multiple-output (MIMO) control field that includes a first partial bandwidth change indication bit indicating there is a change in partial bandwidth for the first beamformee and first partial bandwidth information indicating a first partial bandwidth for the first beamformee that is within the first bandwidth, wherein the second report frame includes a second MIMO control field that includes a second partial bandwidth change indication bit indicating there is a change in partial bandwidth for the second beamformee and second partial bandwidth information indicating a second partial bandwidth for the second beamformee that is within the first bandwidth; and
wirelessly transmit a multi-user multiple-input multiple-output (MU-MIMO) data frame that includes data intended for the first beamformee in the first partial bandwidth and data intended for the second beamformee in the second partial bandwidth.

19. The wireless device of claim 18, wherein the first partial bandwidth change indication bit is one of bits B14-B16 and B37-B39 of the first MIMO control field.

20. The wireless device of claim 18, wherein the first beamformee acts as a relay between the beamformer and the second beamformee.
